(19) United States
(12) Patent Application Publication
(10) Pub. No.: US 2013/0159591 A1
(43) Pub. Date: Jun. 20, 2013

(54) VERIFYING DATA RECEIVED OUT-OF-ORDER FROM A BUS

(71) Applicants: Victor A. Acuña, Rochester, MN (US); Mark J. Hickey, Rochester, MN (US); Galen A. Lyle, Fort Collins, CO (US); Ibrahim A. Ouda, Rochester, MN (US)

(72) Inventors: Victor A. Acuña, Rochester, MN (US); Mark J. Hickey, Rochester, MN (US); Galen A. Lyle, Fort Collins, CO (US); Ibrahim A. Ouda, Rochester, MN (US)

(73) Assignee: INTERNATIONAL BUSINESS MACHINES CORPORATION, Armonk, NY (US)

(21) Appl. No.: 13/325,701

(22) Filed: Dec. 14, 2011

(51) Int. Cl. G06F 13/36

(52) U.S. Cl. 710/310

(57) ABSTRACT

In an embodiment, load transactions are issued to a bus. The load transactions are stalled if the bus cannot accept additional load transactions, and the load transactions are restarted after the bus can accept the additional load transactions. Responses are received from the bus to the load transactions out-of-order from an order that the load transactions were sent to the bus. The responses comprise data and index values that indicate an order that the load transactions were received by the bus. The data is compared in the order that the load transactions were received by the bus against expected data in the order that the load transaction were sent to the bus.

### FIELD

An embodiment of the invention generally relates to computer systems that use buses to send and receive data.

### BACKGROUND

Computer systems and other electronic devices typically comprise integrated circuits, which may comprise semiconductors, transistors, wires, programmable logic devices, and programmable gate arrays, and which may be organized into chips, circuit boards, storage devices, and processors, among others.

The automated design of integrated circuits requires specification of a logic circuit by a designer. One technique for physically designing digital integrated logic circuits is known as the standard cell technique, in which physical layouts and timing behavior models are created for simple logic functions such as AND, OR, NOT, or FlipFlop. These physical layouts are known as “standard cells.” A large group of pre-designed standard cells is then assembled into a standard cell library. Automated tools read a netlist description of the integrated circuit, or netlist representing the desired logical functionality for a chip (sometimes referred to as a behavioral or register-transfer-level description), and map it into an equivalent netlist composed of standard cells from the selected standard cell library. This process is commonly known as “synthesis.”

A netlist is a data structure representation of the electronic logic system that comprises a set of modules, each of which comprises a data structure that specifies sub-components and their interconnection via wires, which are commonly called “nets.” The netlist describes the way in which standard cells and blocks are interconnected. Netlists are typically available in VERILOG, EDIF (Electronic Design Interchange Format), or VHDL (Very High Speed Integrated Circuit Hardware Design Language) formats.

Other tools read a netlist comprised of standard cells and create a physical layout of the chip by placing the cells relative to each other to minimize timing delays or wire lengths, then creating electrical connections (or routing) between the cells to physically complete the design of the desired circuit. The design may then be sent to a fabrication vendor that fabrics a chip that implements the circuit (an application-specific integrated circuit or ASIC), or the design may loaded into a field programmable gate array (FPGA). An FPGA comprises programmable logic components called logic blocks and a hierarchy of reconfigurable interconnects, which allow the blocks to be inter-wired in many different configurations.

One use of an FPGA is to verify the correct implementation of a bus protocol architecture. A bus is computer hardware that connects computer components and allows them to inter-communicate. A correct implementation of a bus protocol architecture sends the correct data between the interconnected components.

### SUMMARY

A method, computer-readable storage medium, and computer system are provided. In an embodiment, load transactions are issued to a bus. The load transactions are stalled if the bus cannot accept additional load transactions, and the load transactions are restarted after the bus can accept the additional load transactions. Responses may be received from the bus to the load transactions out-of-order from an order that the load transactions were sent to the bus. The responses comprise data and index values that indicate an order that the load transactions were received by the bus. The data is compared in the order that the load transactions were received by the bus against expected data in the order that the load transaction were sent to the bus.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a block diagram of an example controller, according to an embodiment of the invention.

FIG. 3 depicts a flowchart of example processing for creating an FPGA image, according to an embodiment of the invention.

FIG. 4 depicts a block diagram of an example bus transaction generator and checker, according to an embodiment of the invention.

FIG. 5 depicts a flowchart of example processing for an issue transaction, according to an embodiment of the invention.

FIG. 6 depicts a flowchart of example processing for ensuring that all transaction data has been received, according to an embodiment of the invention.

FIG. 7 depicts a block diagram of an example bus transaction generator and checker, according to an embodiment of the invention.

It is to be noted, however, that the appended drawings illustrate only example embodiments of the invention, and are therefore not considered a limitation of the scope of other embodiments of the invention.

### DETAILED DESCRIPTION

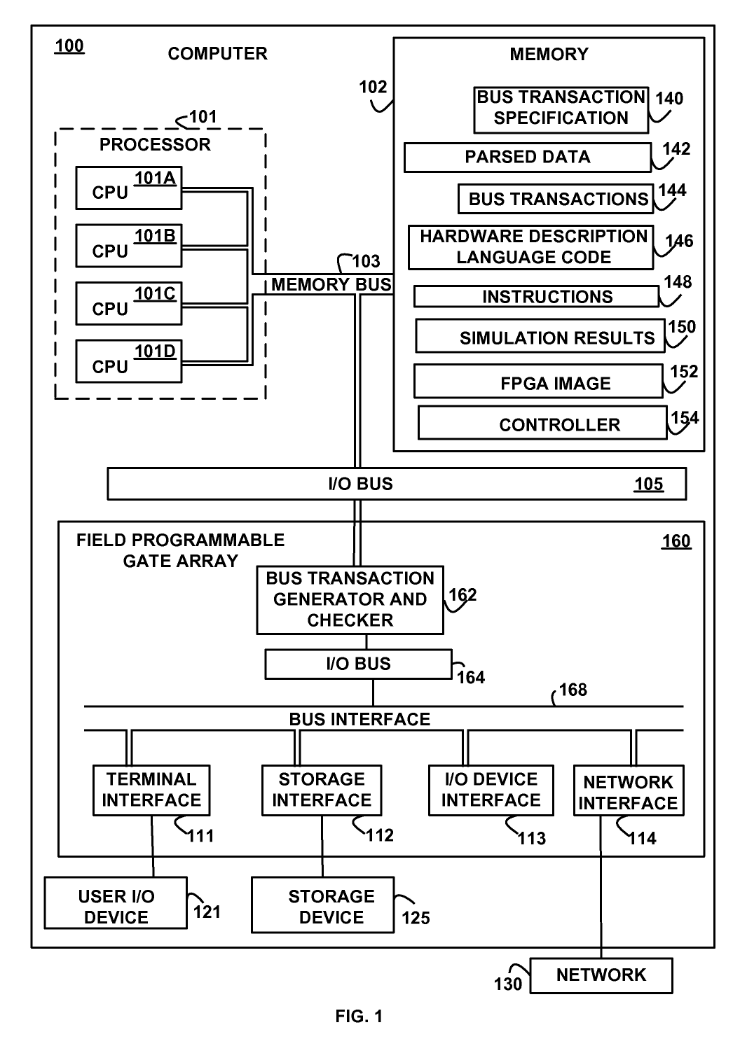

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 comprise one or more processors 101, a memory 102, and a Field Programmable Gate Array (FPGA) 160, which are communicatively coupled, directly or indirectly, for inter-component communication via a memory bus 103, and an I/O (Input/Output) bus 105. The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the memory 102 and may comprise one or more levels of on-board cache.

In an embodiment, the memory 102 may comprise a random-access semiconductor memory, storage device, or storage medium (either volatile or non-volatile) for storing or encoding data and programs. In another embodiment, the memory 102 represents the entire virtual memory of the computer system 100, and may also include the virtual memory of other computer systems coupled to the computer system 100 or connected via the network 130. The memory 102 is conceptually a single monolithic entity, but in other embodiments the memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 stores or encodes a bus transaction specification 140, parsed data 142, bus transactions 144, hardware description language code 146, instructions 148, simulation results 150, an FPGA image 152, and a controller 154. Although the bus transaction specification 140, the parsed data 142, the bus transactions 144, the hardware description language code 146, the instructions 148, the simulation results 150, the FPGA image 152, and the controller 154 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the bus transaction specification 140, the parsed data 142, the bus transactions 144, the hardware description language code 146, the instructions 148, the simulation results 150, the FPGA image 152, and the controller 154 are illustrated as being contained within the memory 102, these elements are not necessarily all completely contained in the same storage device at the same time. Further, although the bus transaction specification 140, the parsed data 142, the bus transactions 144, the hardware description language code 146, the instructions 148, the simulation results 150, the FPGA image 152, and the controller 154 are illustrated as being separate entities, in other embodiments some of them, portions of some of them, or all of them may be packaged together.

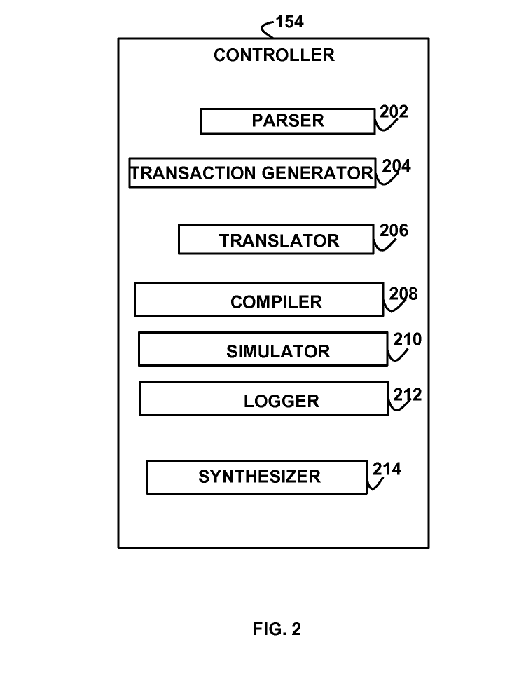

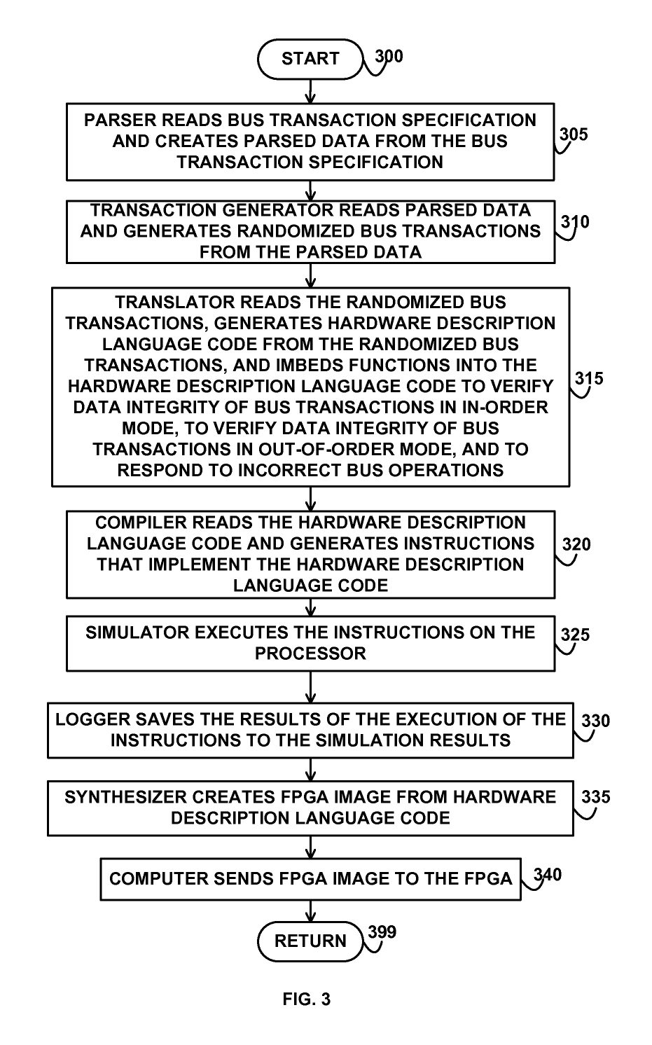

In an embodiment, the instructions 148 and/or the controller 154 comprise instructions or statements that execute on the processor 101 or instructions or statements that are interpreted by instructions or statements that execute on the processor 101, to carry out the functions as further described below with reference to FIGS. 2 and 3. In another embodiment, the instructions 148 and/or the controller 154 are implemented in hardware via semiconductor devices, chips, logical gates, circuits, circuit cards, and/or other physical hardware devices in lieu of, or in addition to, a processor-based system. In an embodiment, the instructions 148 and/or the controller 154 comprise data in addition to instructions or statements. In various embodiments, the controller 154 is a user application, a third-party application, an operating system, or any portion, multiple, or combination thereof.

The bus transaction specification 140 specifies parameters or data that define the operational characteristics of the I/O bus 164. The bus transaction specification 140 may be specified by a user, via the user I/O device 121 or may be received from an application or the network 130. In an embodiment, the bus transaction specification 140 may comprise the width of the I/O bus 164, such as the number of bits, bytes, words, or double words that the I/O bus 164 sends and/or receives simultaneously. In an embodiment, the bus transaction specification 140 specifies or identifies the out-of-order capabilities, the streaming capabilities, and/or the compatibility modes supported by the I/O bus 164.

The bus transactions 144 comprise a series of randomized load/store pair operations. The store operation sends data across the bus to a location and the corresponding load operation reads the data from the same location and compares the read data to the stored data. In an embodiment, if the read data is equal to the stored data, then that load/store pair was successful, and if the read data is not equal to the stored data then that load/store pair was unsuccessful. In an embodiment, if a store operation specifies an invalid (i.e., a non-existent location), then a read issued to that invalid location will likely not return data that matches the attempted store data. Invalid locations are maintained in a mapping. If the store location specified by a store operation is invalid, as indicated by the mapping, the corresponding load operation is not compared against any data and does not indicate an unsuccessful comparison. Instead, the load operation indicates whether or not the bus protocol can handle and respond to store and load operations that specify invalid locations.

In an embodiment, the hardware description language code 146 is specified in a Very High Speed Integrated Circuit Hardware Description Language (VHDL) format and specifies the design of the FPGA 160, but in other embodiments any appropriate hardware description language may be used.

The memory bus 103 provides a data communication path for transferring data among the processor 101, the memory 102, and the I/O bus 105. The I/O bus 105 is further coupled to the FPGA 160. The FPGA 160 comprises a bus transaction generator and checker 162, an I/O bus 164, a bus interface 168, and I/O adapters or I/O processors, such as the terminal interface unit 111, the storage interface unit 112, the I/O device interface 113, and the network interface 114. The bus transaction generator and checker 162 is connected to the I/O bus 105 and the I/O bus 164, which is connected to the bus interface 168. The bus interface 168 is connected to the terminal interface unit 111, the storage interface unit 112, the I/O device interface 113, and the network interface 114. An example of the I/O bus 164 is the 60Xe bus, but in other embodiments any appropriate bus may be used.

The I/O interface units 11, 112, 113, and 114 support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer system 100, and may receive output data via the user output devices. For example, a user interface may be presented via the user I/O device 121, such as displayed on a display device, played via a speaker, or printed via a printer.

The storage interface unit 112 supports the attachment of one or more disk drives or direct access storage devices 125 (which are typically rotating magnetic disk drive storage devices, although they could alternatively be other storage devices, including arrays of disk drives configured to appear as a single large storage device to a host computer). In another embodiment, the storage device 125 may be implemented via any type of secondary storage device. The contents of the memory 102, or any portion thereof, may be stored to and retrieved from the storage device 125, as needed. The I/O device interface 113 provides an interface to any of various other input/output devices or devices of other types, such as printers or fax machines. The network interface 114 provides one or more communications paths from the computer system 100 to other digital devices and computer systems; such paths may comprise, e.g., one or more networks 130. The other computer systems in the network 130 may comprise some or all of the hardware and program components illustrated for the computer 100.

Although the memory bus 103 is shown in FIG. 1 as a relatively simple, single bus structure providing a direct communication path among the processors 101, the memory 102, and the I/O bus 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration.

In various embodiments, the computer system 100 is a multi-user mainframe computer system, a single-user system, or a server computer or similar device that has little or no direct user interface, but receives requests from other computer systems (clients). In other embodiments, the computer system 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the computer system 100 and other computer systems. In various embodiments, the network 130 may represent a storage device or a combination of storage devices, either connected directly or indirectly to the computer system 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

FIG. 1 is intended to depict the representative major components of the computer system 100, and the network 130. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.”

The computer programs comprise one or more instructions or statements that are resident at various times in various memory and storage devices in the computer system 100 and that, when read and executed by one or more processors in the computer system 100 or when interpreted by instructions that are executed by one or more processors, cause the computer system 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the storage device 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments of the invention.

FIG. 2 depicts a block diagram of an example controller 154, according to an embodiment of the invention. The controller 154 comprises a parser 202, a transaction generator 204, a translator 206, a compiler 208. a simulator 210, a logger 212, and a synthesizer 214

FIG. 3 depicts a flowchart of example processing for creating an FPGA image, according to an embodiment of the invention. Control begins at block 300. Control then continues to block 305 where the parser 202 reads the bus transaction specification 140 and creates the parsed data 142 from the bus transaction specification 140. Control then continues to block 310 where the transaction generator 204 reads the parsed data 142 and generates randomized bus transactions 144 from the parsed data 142. In an embodiment, the bus transaction specification 140 comprises multiple bus transaction specifications, so that the transaction generator 204 generates a set of bus transactions for each individual specification, where each specification is isolated from all other specifications, in order to enable regression testing.

In order to generate a set of randomized bus transactions 144, the transaction generator 204 determines the data to be sent to the address ranges in the peripheral devices connected (directly or indirectly) to the I/O bus 164 (e.g., the user I/O device 121, the storage device 125, and the network 130) and the ordering constraints imposed on the data. For example, one of the options in the bus transaction specification 140 allows for burst data transfers to peripheral devices, mapped by address ranges. But, not all peripheral devices support burst-mode operation, and those which do support burst-mode operations may return results in different data beat orderings, depending on which critical double-word (each double word is eight bytes) is specified in the address supplied by the generated transaction. Therefore, in an embodiment, the transaction generator 204 only generates burst transactions, either store or load transactions, for address ranges corresponding to peripheral devices that the transaction generator 204 knows support burst transactions. The transaction generator 204 further maintains a record of data expected in the load transaction based on critical double-word ordering specified in the generated load transaction address.

Broad ordering constraints in the bus transaction specification 140, such as whether or not entire transactions may be received or transmitted across the bus out-of-order, cause the transaction generator 204 to add additional constraints to the generated bus transactions 144. If the bus transaction specification 140 specifies an in-order operation, then the transaction generator 204 maintains the data of each store transaction in the memory 102, which allows the transaction generator 204 to track potential overwrites of bus memory locations available to the peripheral devices. By tracking such overwrites, the transaction generator 204 maintains perfect knowledge of what data should be expected when a load transaction issues to any location. The transaction generator 204 may then issue a load transaction and compare the received data to the expected data.

If the bus transaction specification 140 specifies an out-of-order operation, then the transaction generator 204 can no longer maintain perfect knowledge of the state of the I/O bus 164. Out-of-order tracking is handled by the hardware description language code 146, which utilizes the bus interface 168 to assist in limited tracking. As the tracking hardware description language code 146 is more restrictive than that of the tracking utilized by the transaction generator 204 when operating in in-order mode, the transaction generator 204 ensures that no two store transactions issue to the same address or overlapping 32 byte address range unless at least 32 additional store transactions have occurred to non-overlapping addresses. In order to meet this requirement when operating in out-of-order mode, the transaction generator 204 first generates bus transactions 144 as it would when operating in in-order mode, and then the transaction generator 204 removes any store transactions which would violate the rule that no overwrites be allowed unless 32 other store transactions have occurred.

Control then continues to block 315 where the translator 206 reads the randomized bus transactions 144 and generates the hardware description language code 146 from the randomized bus transactions 144. The translator 206 imbeds functions into the hardware description language code 146 to verify data integrity of bus transactions in in-order mode, to verify data integrity of bus transactions in out-of-order mode, and to respond to incorrect bus operations. Based on the ordering constraints, the hardware description language code 146 may or may not included a tracking mechanism to ensure correct comparisons of data returned from the simulated bus model. Thus, each store transaction has a corresponding load transaction as dictated by the bus transaction generator 204, and data returned from each load transaction is compared against the data which was stored. Depending on the reporting desired, the hardware description language code 146 may include a mechanism to either count the number of incorrect bus transactions, or issue a breakpoint to the simulation environment that is simulating the VHDL logic and the model of the I/O bus 164.

Control then continues to block 320 where the compiler 208 reads the hardware description language code 146 and generates instructions 148 that implement the hardware description language code 146.

Control then continues to block 325 where a simulator 210 executes the instructions 148 on the processor 101. In an embodiment, a logic simulation environment, such as the Incisive tool suite available from Cadence Design Systems may be used as a simulator 210, but in other embodiments, ModelSim, available from Mentor Graphics or any appropriate simulator may be used.

Control then continues to block 330 where the logger 212 saves the results of the execution of the instructions 148 to the simulation results 150 and optionally displays the simulation results 150 to a user, e.g., via the user I/O device 121.

Control then continues to block 335 where the synthesizer 214 creates the FPGA image 152 from the hardware description language code 146. Control then continues to block 340 where the computer sends the FPGA image 152 to the FPGA 160, which stores, saves or installs the FPGA image 152 at the FPGA 160. Control then continues to block 399 where the logic of FIG. 3 returns.

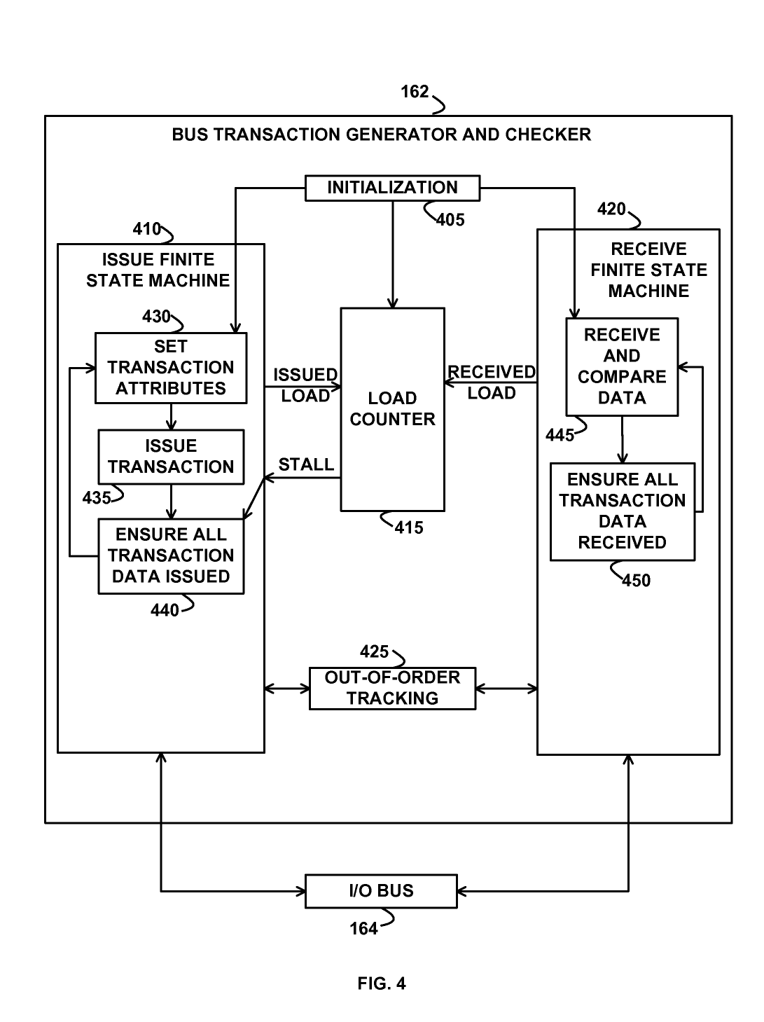

FIG. 4 depicts a block diagram of an example bus transaction generator and checker 162, according to an embodiment of the invention. The bus transaction generator and checker 162 comprises initialization logic 405, an issue finite state machine 410, a load counter 415, a receive finite state machine 420, and out-of-order tracking logic 425. The initialization logic 405 is connected to the issue finite state machine 410, the load counter 415, and the receive finite state machine 420. The issue finite state machine 410 is connected to the load counter 415, the out-of-order tracking logic 425, and the I/O bus 164. The receive finite state machine 420 is connected to the load counter 415, the out-of-order tracking logic 425, and the I/O bus 164.

In response to a power on, reset, or startup of the FPGA 160, the initialization logic 405 initializes the states of the issue finite state machine 410 and the receive finite state machine 420. The initialization logic 405 further initializes a counter in the load counter 415 to be zero.

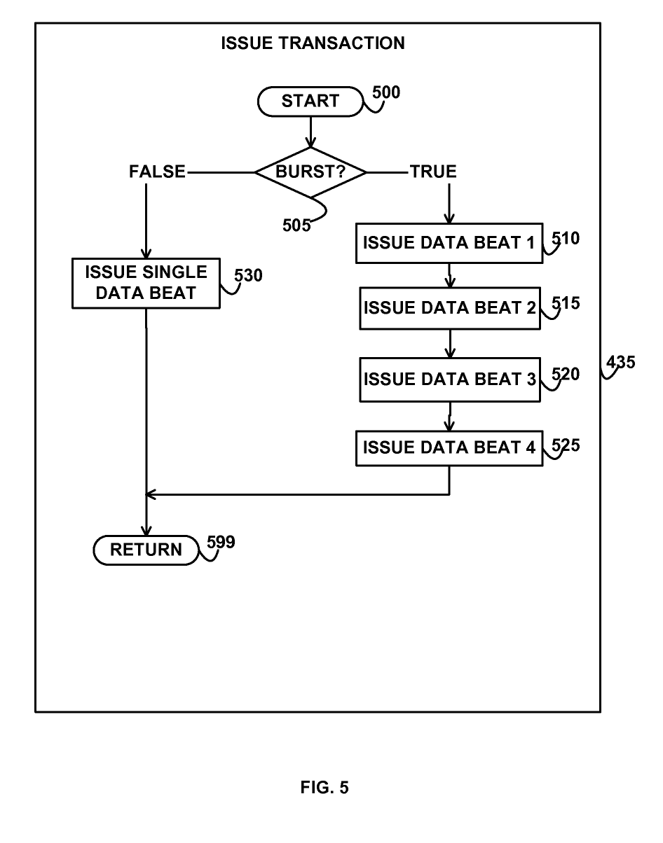

The issue finite state machine 410 comprises set transaction attributes logic 430, issue transaction logic 435, and ensure all transaction data issued logic 440. The set transaction attributes logic 430 determines and sets the attributes of the current transaction, such as whether the current transaction is a load or a store, the data to be stored, the address in the peripheral device at which the data is to be loaded or stored, and whether the mode of the transaction operates in in-order mode or out-of order mode. The set transaction attributes logic 430 configures the I/O bus 164 to operate in either burst or non-burst mode. The issue transaction logic 435 issues store and load transactions to the I/O bus 164. In response to issuing a load transaction to the I/O bus 164, the issue transaction logic 435 sends an issued load signal to the load counter 415. The issue transaction logic 435 is further described below with reference to FIG. 5. The ensure all transaction data issued logic 440 determines whether all data beats of the transaction have been issued to the I/O bus 164 and whether a stall signal is asserted by the load counter 415. If the stall signal is asserted or all data beats of the transaction have not been sent to the I/O bus 164, then the ensure all transaction data issued logic 440 stalls or suspends the set transaction attributes logic 430 or does not allow the set transaction attributes logic 430 to process the next transaction. If the stall signal is not asserted and all data beats of the transaction have been sent to the I/O bus 164, then the ensure all transaction data issued logic 440 allows the set transaction attributes logic 430 to process the next current transaction or allows the set transaction attributes logic 430 to resume processing transactions if the processing was previously stalled by receipt of the stall signal from the load counter 415.

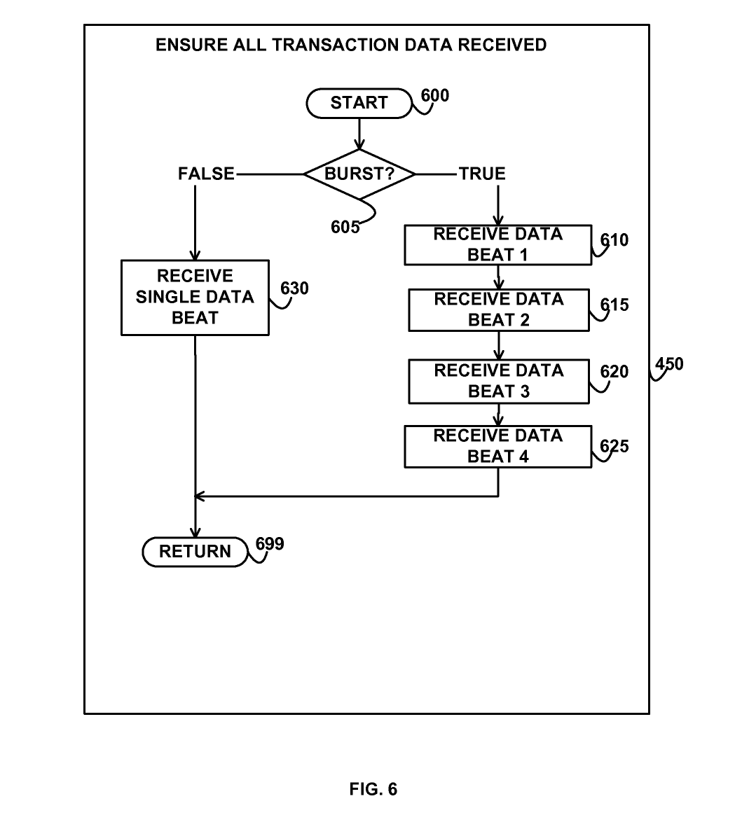

The receive finite state machine 420 comprises receive and compare data logic 445 and ensure all transaction data received logic 450. The receive and compare data logic 445 receives data from the I/O bus 164 that was requested by a prior issued load transaction (issued by the issue transaction logic 435) and compares the received data to expected data. In response to the receive and compare, the receive and compare data logic 445 sends a received load signal to the load counter 415. The ensure all transaction data received logic 450 ensures that all data has been received and compared before allowing the receive and compare data logic 445 to receive and compare data for the next load transaction. The ensure all transaction data received logic 450 is further described below with reference to FIG. 6.

The load counter 415 receives the received load signal from the receive finite state machine 420, receives the issued load signal from the issue finite state machine 410, and sends a stall signal to the ensure all transaction data issued logic 440. In response to the issued load signal, the load counter 415 increments the counter. If response to the received load signal, the load counter 415 decrements the counter. If the counter is greater than a maximum number of allowable outstanding load transactions, then the load counter 415 asserts the stall signal. If the counter is less than or equal to a maximum number of load transactions, then the load counter 415 drops the stall signal, sets the stall signal to low, or stops asserting the stall signal. In various embodiments, the maximum number of load transactions value may be set by a user via the user I/O device 121, read from the bus transaction specification 140, received from an application executing at the computer 100, or received from the network 130.

When operating in in-order mode, the issue finite state machine 410 knows which data should be returned for a given load transaction based on the order in which the load transaction was issued if the data was properly processed by the I/O bus 164 and properly stored and retrieved by the peripheral device communicatively connected to the I/O bus 164. Given the perfect knowledge of the state of the bus when relying on in-order operation, the receive finite state machine 420 hard codes all of the expected data to be compared against.

As an example of in-order operation, if the issue transaction logic 435 sent a data word 0x01234567 with an address 0x80000000 and a data word of 0x89ABCDEF with an address 0x80000020 to the I/O bus 164 followed by a first load issued to address 0x80000000, and a second load issued to address 0x80000020, then the return order of the data from the bus, in in-order operation, should always be 0x01234567 followed by 0x89ABCDEF.

Because for in-order operations, the I/O bus 164 returns the data in the same order that the issue transaction logic 435 issued the load transactions to the I/O bus 164, in an embodiment, the load counter 415 tracks the number of load transactions that are outstanding with no data yet received, which does not exceed a specific threshold amount, the issue finite state machine 410 tracks all data beats of a burst transaction have been issued (as further described below with reference to FIG. 5), and the receive finite state machine 420 tracks the number of data beats for a burst transaction that have been received (as further described below with reference to FIG. 6). But, the out-of-order tracking 425 is not needed for in-order processing.

Critical double-word ordering of burst transactions does not need to be tracked when operating in in-order mode as this ordering can be taken into account when expected data is hardcoded. Transactions are thus issued by the issue transaction logic 435 as long as transactions remain, unless the bus requires stalling the issue finite state machine 410 (as indicated by the stall signal), and the receive and compare data logic 445 compares data as it is received against hardcoded expected data until the bus has returned data for all load transactions. Thus, while performing in-order operations, the issue finite state machine 410 and the receive finite state machine 420 are essentially isolated from one-another, and in an embodiment, the comparisons require no additional information other than the hardcoded data.

When operating in out-of-order mode, however, the issue finite state machine 410 and the receive finite state machine 420 require more communication, which is performed by the out-of-order tracking logic 425. This additional communication occurs because, unlike in-order operation, in out-of-order operations, perfect knowledge of the state of the bus is impractical as delay characteristics of bus peripherals, internal bus mechanisms, and the interaction between the two, is difficult to predict beforehand. Thus, for out-of-order transactions, the order of loads issued cannot be presumed to have any impact on the order of data returned. That is, if a first load is issued to address 0x80000000 followed by a second load issued to address 0x80000020, the data return order could be 0x01234567 followed by 0x89ABCDEF, or it could be 0x89ABCDEF followed by 0x01234567 (using the example data and addresses illustrated above), depending on the state of the I/O bus 164. Due to the unknown ordering of data returned by the I/O bus 164, expected data can no longer be hardcoded into the receive finite state machine 420 because it is unclear which data should be hardcoded into which receiving state. For example, referring back to the load transactions in the aforementioned example, it is unclear whether the first receive state should compare returned data against 0x012345678 or 0x89ABCDEF. Additionally, in an embodiment, the receive interface to the I/O bus 164, accessed by the receive finite state machine 420 exposes no address information, and is inherently decoupled from the issue finite state machine 410, except for an identifier (ID) field which persists between both issued and received transactions, so neither the address used for issuing a load transaction, or other general characteristics of issued transactions may be used for determining the order of expected data to compare.

In an embodiment, the I/O bus 164 bus limits the number of load transactions that may be outstanding at a time and also provides an index signal, which describes how long a load response has been outstanding, as compared to other load responses, by acting as a queue index. An index signal of 0 indicates that the corresponding data is returned in response to the oldest load transaction that the I/O bus 164 received, an index of 1 indicates that the corresponding data is returned in response to the next oldest load transaction that the I/O bus 164 received, and so on. Thus, in the example above, if the issue transaction logic 435 first issues a load transaction to address 0x80000000 and second issues a load transaction to address 0x80000020, then the I/O bus 164 assigns the load to address 0x80000000 an index signal value of 0 since it is the first load transaction issued. If the I/O bus 164 returns data in the order of the data 0x01234567 followed by the data 0x89ABCDEF, then the I/O bus 164 returns with the data 0x01234567 an index signal value of 0 and also returns an index signal value of 0 with the data 0x89ABCDEF because by the time that the I/O bus 164 returns the data of 0x89ABCDEF, this data corresponds to the oldest outstanding load transaction since the load for 0x80000000 has already been received by the receive and compare data logic 445. If the I/O bus 164 instead returns data in the order 0x89ABCDEF followed by 0x01234567, then the I/O bus 164 returns an index signal value of 1 with the data 0x89ABCDEF, and the I/O bus 164 returns an index signal value of 0 with the data 0x01234567.

When operating in out-of-order mode, the issue finite state machine 410 sends copies of the data being stored to the out-of-order tracking logic 425, which supplies the data to the receive finite state machine 420, which later uses the data as expected data to be compared against when data from a corresponding load transaction is received by the receive and compare data logic 445. The issue finite state machine 410 also sends an identifier (ID) to the out-of-order tracking logic 425, which sends the ID to the receive finite state machine 420. The ID identifies the transactions sent by the issue finite state machine 410 and the order that the issue finite state machine 410 sent the identified transactions to the I/O bus 164. The receive finite state machine 420 compares the ID to the index value returned by the I/O bus 164, to match the received data to the load transaction that requested the data. The receive finite state machine 420 stores the received data in a queue in the order specified by the index value and accesses the data from the queue in the order specified by the index value, comparing the accessed data to the data received from the out-of-order tracking logic 425 in the order specified by the ID.

The out-of-order tracking logic 425 may comprise overwrite buffers, which are indexed using the ID. The out-of-order logic 425 may also comprise content-addressable memory, which matches an address to an already used ID whenever an overwrite occurs. The issue finite state machine 410 uses the ID in the issued transaction and also uses the ID to obtain current data from issue data buffers for the purpose of overwriting it as necessary, and supplying such updated data to the receive data buffers. This mechanism ensures that, whenever data is obtained from the receive buffer, it truly represents expected data when used in conjunction with the index signal value.

The issue finite state machine 410 records whether a load transaction was to a valid memory location, whether the load transaction was a burst load, and, if so, which critical double-word was specified, and what starting and ending bits of data should be compared against for single-beat loads off sizes less than 8 bytes. This information is specified to the receive finite state machine 420 by using the index signal value supplied by the I/O bus 164; it is then coupled with data as indexed by the ID returned to the receive finite state machine 420, so that the receive and compare data logic 445 may perform a valid comparison of expected data against received data.

Depending on the type of action desired, the receive and compare data logic 445 may either halt all subsequent transactions in the event of a data mismatch between the data received from the I/O bus 164 in response to a load transaction and the data that was expected to be received, or count the number of such mismatches, and continue processing transactions.

FIG. 5 depicts a flowchart of example processing for the issue transaction logic 435, according to an embodiment of the invention. Control begins at block 500. Control then continues to block 505 where the logic determines whether the transaction is a burst transaction. If the determination at block 505 is true, then the transaction is a burst transaction, so control continues to block 510 where the logic issues a first data beat of the transaction to the I/O bus 164. Control then continues to block 515 where the logic issues a second data beat of the transaction to the I/O bus 164. Control then continues to block 520 where the logic issues a third data beat of the transaction to the I/O bus 164. Control then continues to block 525 where the logic issues a fourth data beat of the transaction to the I/O bus 164. In this way, in an embodiment, the issue transaction logic 435 issues four data beats in a burst transaction, where each beat is a double word. In another embodiment, the issue transaction logic 435 may issue any number of data beats in a burst transaction. Control then continues to block 599 where the logic of FIG. 5 returns.

If the determination at block 505 is false, then the transaction is not a burst transaction, so control continues to block 530 where the issue transaction issues a single data beat to the I/O bus 164. Control then continues to block 599 where the logic of FIG. 5 returns.

FIG. 6 depicts a flowchart of example processing for logic 450 for ensuring that all transaction data has been received, according to an embodiment of the invention. Control begins at block 600. Control then continues to block 605 where the logic determines whether the transaction is a burst transaction. If the determination at block 605 is true, then the transaction is a burst transaction, so control continues to block 610 where the logic receives a first data beat of the transaction from the I/O bus 164. Control then continues to block 615 where the logic receives a second data beat of the transaction from the I/O bus 164. Control then continues to block 620 where the logic receives a third data beat of the transaction from the I/O bus 164. Control then continues to block 625 where the logic receives a fourth data beat of the transaction from the I/O bus 164. In this way, in an embodiment, the logic 450 for the ensure all transaction data received operation receives four data beats in a burst transaction, where each beat is a double word. In another embodiment, the logic 450 may receive any number of data beats in a burst transaction. Control then continues to block 699 where the logic of FIG. 6 returns.

If the determination at block 605 is false, then the transaction is not a burst transaction, so control continues to block 630 where the logic receives a single data beat from the I/O bus 164. Control then continues to block 699 where the logic of FIG. 6 returns.

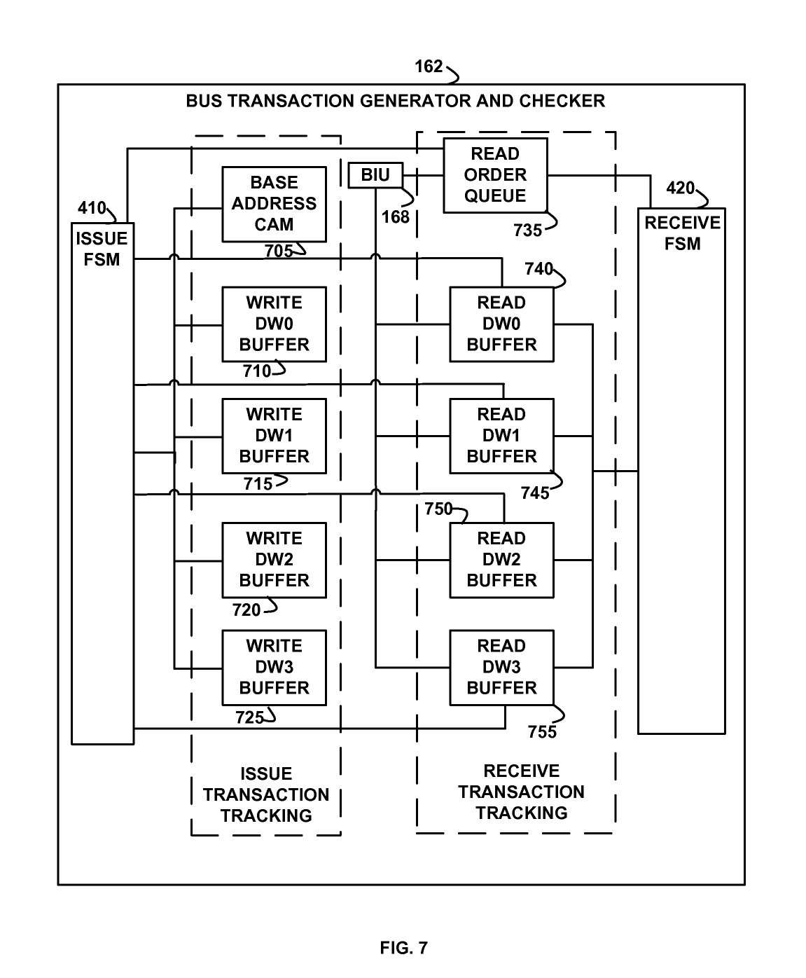

FIG. 7 depicts a block diagram of an example bus transaction generator and checker 162, according to an embodiment of the invention. The example bus transaction generator and checker 162 comprises an example BIU (Bus Interface Unit) 168, an issue FSM (Finite State Machine) 410, a receive FSM 420, a base address CAM (Content Addressable Memory) 705, a write DW0 (data word zero) buffer 710, a write DW1 (data word one) buffer 715, a write DW2 (data word two) buffer 720, a write DW3 (data word three) buffer 725, a read order queue 735, a read DW0 (data word zero) buffer 740, a read DW1 (data word one) buffer 745, a read DW2 (data word two) buffer 750, and a read DW3 (data word three) buffer 755.

The issue FSM 410 is connected to the base address CAM 705, the write DW0 buffer 710, the write DW1 buffer 715, the write DW2 buffer 720, the write DW3 buffer 725, the read order queue 735, the read DW0 buffer 740, the read DW1 buffer 745, the read DW2 buffer 750, and the read DW3 buffer 755. The bus address CAM 705 is connected to the issue FSM 410, the write DW0 buffer 710, the write DW1 buffer 715, the write DW2 buffer 720, and the write DW3 buffer 725. The BIU 168 is connected to the read order queue 735, the read DW0 buffer 740, the read DW1 buffer 745, the read DW2 buffer 750, and the read DW3 buffer 755. The read order queue 735 is connected to the BIU 168 and the receive FSM 420. The receive FSM 420 is connected to the read order queue 735, the read DW0 buffer 740, the read DW1 buffer 745, the read DW2 buffer 750, and the read DW3 buffer 755.

The base address CAM 705, the write DW0 buffer 710, the write DW1 buffer 715, the write DW2 buffer 720, and the write DW3 buffer 725 perform issue tracking. The read order queue 735, the read DW0 buffer 740, the read DW1 buffer 745, the read DW2 buffer 750, and the read DW3 buffer 755 perform receive transaction tracking.

The issue FSM 410 selects a transfer which specifies, along with other information, an address, which the issue FSM 410 copies. The issue FSM 410 converts the copy of this address into a base address. A base address is an address meeting the minimum addressability requirements to accommodate the largest transfer supported by the I/O bus 164. For example, if the largest transfer is a burst consisting of four double-words, then the issue FSM 410 converts a 32-bit address into a base address by setting the five low order address bits to 0.

The issue FSM 410 supplies the base address to the base address CAM 705, which performs a lookup using the supplied base address. If no match exists for the supplied base address in the base address CAM 705, then the issue FSM 410 assigns an unused ID to the base address and updates the base address CAM 705 with the base address and ID, in order to associate the ID with the specified base address. If there is a match for the supplied base address in the CAM 705, then the issue FSM 410 uses the ID already associated with the base address, as specified by the base address CAM 705.

If the selected transfer is a store operation, and is not additionally a burst operation, the issue FSM 410 examines the transfer address to determine which of the write DW0 buffer 710, the write DW1 buffer 715, the write DW2 buffer 720, or the write DW0 buffer 725 should be accessed. If the store operation specifies a transfer that is smaller than a double-word, then the issue FSM 410 first reads the data from the selected buffer, as indexed by the ID described above and then updates the selected buffer with the data to be written. For example, if the transfer address specified the write DW0 buffer 710, the ID specified the entry 0 of the write DW0 buffer 710, the entry 0 contained the data 0x01234567_89ABCDEF, and the write operation indicated that only the rightmost byte be written with 0x00, then the issue FSM 410 updates data at entry 0 of the write DW0 buffer 710 with the value 0x01234567_{—}89ABCD00. If the store operation specifies a transfer that is a double word, then the issue FSM 410 overwrites all data in the selected buffer, as indexed by the ID described above. If the store operation specifies a burst operation as well, then the issue FSM 410 overwrites data in all buffers, as indexed by the ID described above. In addition, the data that the issue FSM 410 writes into write DW0 buffer 710, write DW1 buffer 715, write DW2 buffer 720, and/or write DW0 buffer 725, accounting for any updates as described, is also written to the corresponding buffers read DW0 buffer 740, read DW0 buffer 745, read DW0 buffer 750, read DW0 buffer 755. At this point, the read buffers contain data, to be used for comparisons, which account for the possibility of being partially overwritten. The issue FSM 410 then issues the transfer to the I/O bus 164.

If the selected transfer is a load operation, then the ID, a buffer selection indicator determined in a manner similar to that described above, and an indicator specifying a range of bits to compare, if any, are entered into the read order queue 735 by the issue FSM 410. A range of bits to compare is used whenever the load transfer specifies an operation that is smaller than a double-word; otherwise, all bits of data output from read DW0 buffer 740, read DW0 buffer 745, read DW0 buffer 750, and/or read DW0 buffer 755 are compared. The issue FSM 410 then issues the transfer to the I/O bus 164.

The I/O bus 164 returns an index as previously described above along with data, when operating in out-of-order mode, whenever a load transfer is completed. This index is used by the receive FSM 420 to obtain a corresponding entry from the read order queue 735. This entry, as discussed above, contains an ID, buffer selection indicator, and bit range indicator. The receive FSM 420 uses the buffer selection indicator to determine which of read DW0 buffer 740, read DW0 buffer 745, read DW0 buffer 750, or read DW0 buffer 755, possibly all, should be selected. The receive FSM 420 then uses the ID to read an entry from the selected buffer. The receive FSM 420 then compares data returned from the I/O bus 164 using the data read from the selected buffer. If the bit range indicator indicates that only a portion of the data read from the selected buffer should be used, then the receive FSM 420 compares only that portion of the data.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
issuing load transactions to a bus;
stalling the issuing the load transactions to the bus if the bus cannot accept additional load transactions and restarting the issuing after the bus can accept the additional load transactions;
receiving responses to the load transactions from the bus out-of-order from an order that the issuing sent the load transactions to the bus, wherein the responses comprise data and index values that indicate an order that the load transactions were received by the bus; and
comparing data in the responses in the order that the load transactions were received by the bus against expected data in the order that the load transaction were sent by the issuing.

2. The method of claim 1, wherein the stalling the issuing the load transactions to the bus if the bus cannot accept the additional load transactions further comprises:
incrementing a counter in response to the issuing the load transactions.

3. The method of claim 2, wherein the stalling the issuing the load transactions to the bus if the bus cannot accept the additional load transactions further comprises:
decrementing the counter in response to the receiving the responses to the load transactions.

4. The method of claim 3, wherein the stalling the issuing the load transactions to the bus if the bus cannot accept the additional load transactions further comprises:
stalling the issuing the transactions to the bus if the counter is greater than a maximum number of outstanding load transactions.

5. The method of claim 4, wherein the restarting the issuing after the bus can accept the additional load transactions further comprises:
restarting the issuing the transactions to the bus if the counter is less than the maximum number of outstanding load transactions.

6. The method of claim 1, further comprising:
creating a field programmable gate array image that performs the issuing, the stalling, the receiving, and the comparing; and
sending the field programmable gate array image to a field programmable gate array.

7. The method of claim 6, wherein the creating the field programmable gate array image further comprises:
creating parsed data from a bus transaction specification.

8. The method of claim 7, wherein the creating the field programmable gate array image further comprises:
generating randomized bus transactions from the parsed data.

9. The method of claim 8, wherein the creating the field programmable gate array image further comprises:
generating hardware description language code from the randomized bus transactions; and
imbedding functions into the hardware description language code to verify data integrity of the bus transactions.

10. A computer-readable storage medium encoded with instructions, wherein the instructions when executed comprise:
creating a field programmable gate array image; and
sending the field programmable gate array image to a field programmable gate array, wherein the field programmable gate array performs
issuing load transactions to a bus,
stalling the issuing the load transactions to the bus if the bus cannot accept additional load transactions and restarting the issuing after the bus can accept the additional load transactions,
receiving responses to the load transactions from the bus out-of-order from an order that the issuing sent the load transactions to the bus, wherein the responses comprise data and index values that indicate an order that the load transactions were received by the bus, and
comparing data in the responses in the order that the load transactions were received by the bus against expected data in the order that the load transaction were sent by the issuing.

11. The computer-readable storage medium of claim 10, wherein the stalling the issuing the load transactions to the bus if the bus cannot accept the additional load transactions further comprises:
incrementing a counter in response to the issuing the load transactions.

12. The computer-readable storage medium of claim 11, wherein the stalling the issuing the load transactions to the bus if the bus cannot accept the additional load transactions further comprises:
decrementing the counter in response to the receiving the responses to the load transactions.

13. The computer-readable storage medium of claim 12, wherein the stalling the issuing the load transactions to the bus if the bus cannot accept the additional load transactions further comprises:
stalling the issuing the transactions to the bus if the counter is greater than a maximum number of outstanding load transactions.

14. The computer-readable storage medium of claim 13, wherein the restarting the issuing after the bus can accept the additional load transactions further comprises:
restarting the issuing the transactions to the bus if the counter is less than the maximum number of outstanding load transactions.

15. The computer-readable storage medium of claim 10, wherein the creating the field programmable gate array image further comprises:
creating parsed data from a bus transaction specification;
generating randomized bus transactions from the parsed data;
generating hardware description language code from the randomized bus transactions; and
imbedding functions into the hardware description language code to verify data integrity of the bus transactions.

16. A computer comprising:
a processor;
a field programmable gate array comprising a field programmable gate array image; and
memory communicatively coupled to the processor and the field programmable gate array, wherein the memory is encoded with instructions, and wherein the instructions when executed by the processor comprise:
creating the field programmable gate array image, and
sending the field programmable gate array image to the field programmable gate array, wherein the field programmable gate array image causes the field programmable gate array to perform
issuing load transactions to a bus,
stalling the issuing the load transactions to the bus if the bus cannot accept additional load transactions and restarting the issuing after the bus can accept the additional load transactions,
receiving responses to the load transactions from the bus out-of-order from an order that the issuing sent the load transactions to the bus, wherein the responses comprise data and index values that indicate an order that the load transactions were received by the bus, and
comparing data in the responses in the order that the load transactions were received by the bus against expected data in the order that the load transaction were sent by the issuing.

17. The computer of claim 16, wherein the stalling the issuing the load transactions to the bus if the bus cannot accept the additional load transactions further comprises:
incrementing a counter in response to the issuing the load transactions; and
decrementing the counter in response to the receiving the responses to the load transactions.

18. The computer of claim 17, wherein the stalling the issuing the load transactions to the bus if the bus cannot accept the additional load transactions further comprises:
stalling the issuing the transactions to the bus if the counter is greater than a maximum number of outstanding load transactions.

19. The computer of claim 18, wherein the restarting the issuing after the bus can accept the additional load transactions further comprises:
restarting the issuing the transactions to the bus if the counter is less than the maximum number of outstanding load transactions.

20. The computer of claim 16, wherein the creating the field programmable gate array image further comprises:
creating parsed data from a bus transaction specification;
generating randomized bus transactions from the parsed data;
generating hardware description language code from the randomized bus transactions; and
imbedding functions into the hardware description language code to verify data integrity of the bus transactions.
